(19) United States
(12) Patent Application Publication
(10) Pub. No.: US 2020/0265409 A1
(43) Pub. Date: Aug. 20, 2020

(54) SYSTEMS AND METHODS TO SPLIT BILLS AND REQUESTS FOR PAYMENT FROM DEBIT OR CREDIT ACCOUNT

(71) Applicant: JPMorgan Chase Bank, N.A., New York, NY (US)

(72) Inventor: Jeevan Babu, Scarsdale, NY (US)

(21) Appl. No.: 16/279,314

(22) Filed: Feb. 19, 2019

(51) Int. Cl. G06Q 20/22; G06Q 20/10; G06Q 20/32; G06N 20/00

(52) U.S. Cl. CPC G06Q 20/227; G06Q 20/29; G06N 20/00; G06Q 20/3223; G06Q 20/102

(57) ABSTRACT

The invention relates to a method to send a split payment request directly from a paying customer's debit or credit account. According to an embodiment of the present invention, the method comprises the steps of, in a mobile payment computer application executed by an information processing apparatus comprising at least one computer processor: receiving a split payment request for a transaction; displaying a list of other customers for the split payment request; receiving a selection of one of the other customers for the split payment request; receiving a selection of a payment allocation for the selected other customer; and communicating the split payment request, the selected other customer, and the payment allocation to a remote server.

### BACKGROUND OF THE INVENTION

### 1. Field of the Invention

The present disclosure relates to systems and methods to split bills among a plurality of customers, and systems and methods for a paying customer to request payment from other customers.

### 2. Description of the Related Art

To simplify the payment process, groups of customers of a merchant often provide the merchant with a single payment instrument, such as credit card or debit card, to pay the merchant in a single transaction rather than have the merchant run multiple transactions. Examples are when groups of customers go out to dinner, to a sporting event, to a movie, etc. Unless the other customers provide payment to the customer that provided the payment instrument at the time of transaction, the customer that provided the payment instrument may have to collect from the other customers, putting both the customer that provided the payment instrument and the other customer in an uncomfortable situation.

### SUMMARY

Exemplary embodiments provide a system and method for sending a split payment request directly from a paying customer's debit or credit account. According to one embodiment, a method comprises the steps of, in a mobile payment computer application executed by an information processing apparatus comprising at least one computer processor: receiving a split payment request for a transaction; displaying a list of other customers for the split payment request; receiving a selection of one of the other customers for the split payment request; receiving a selection of a payment allocation for the selected other customer; and communicating the split payment request, the selected other customer, and the payment allocation to a remote server.

In other embodiments, in an information processing apparatus comprising at least one computer processor, a computer-implemented method may include the steps of: receiving from the paying customer electronic device a split payment request for a transaction, a selection of an other customer, and a payment allocation for the other customer; receiving from the paying customer electronic device a split payment request for a transaction, a selection of an other customer, and a payment allocation for the other customer; sending a payment request for the payment allocation to the other customer; and receiving payment information for the payment allocation from the other customer.

In other embodiments, a computer-implemented system for sending a split payment request directly from a paying customer's debit or credit account may include a communications network; an electronic device associated with a paying customer comprising at least one processor, coupled to the communications network; and a server comprising at least one processor, coupled to the communications network; wherein the electronic device receives an identification of a transaction for a split payment request; the electronic device displays a list of other customers for the split payment request; the electronic device receives a selection of an other customer for the split payment request; the electronic device receives a payment allocation for the selected other customer; the electronic device sends the split payment request, via the communications network, to the server; the server sends the split payment request to the selected other customer; and the server receives payment information from selected other customer.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for splitting bills according to an exemplary embodiment.

FIG. 2 depicts a method for splitting bills according to an exemplary embodiment.

FIG. 3 is an exemplary graphical user interface for selecting transactions in an account activity view in a debit or credit account according to an exemplary embodiment.

FIG. 4 is a diagram of a graphical user interface with options for selecting other customers for a payment request according to an exemplary embodiment.

FIG. 5 is a diagram of a graphical user interface with options for splitting a payment request according to an exemplary embodiment.

FIG. 6 depicts a flowchart of a method for splitting bills according to an exemplary embodiment.

### DETAILED DESCRIPTION

Exemplary embodiments will now be described in order to illustrate various features. The embodiments described herein are not intended to be limiting as to the scope, but rather are intended to provide examples of the components, use, and operation of the invention.

According to certain embodiments, a paying customer may view his or her debit or credit account, select one or more transactions for a split payment request, select one or more other customers, select how the payment request should be divided, and submit a split payment request to the selected other customers. In alternative embodiments, a paying customer may send a split payment request without selecting a transaction, concurrent with a transaction, or after a transaction has already posted.

One of ordinary skill in the art will readily appreciate that such embodiments advantageously allow a paying customer to request split payments directly from his or her debit or credit account for one or more transactions to one or more other customers.

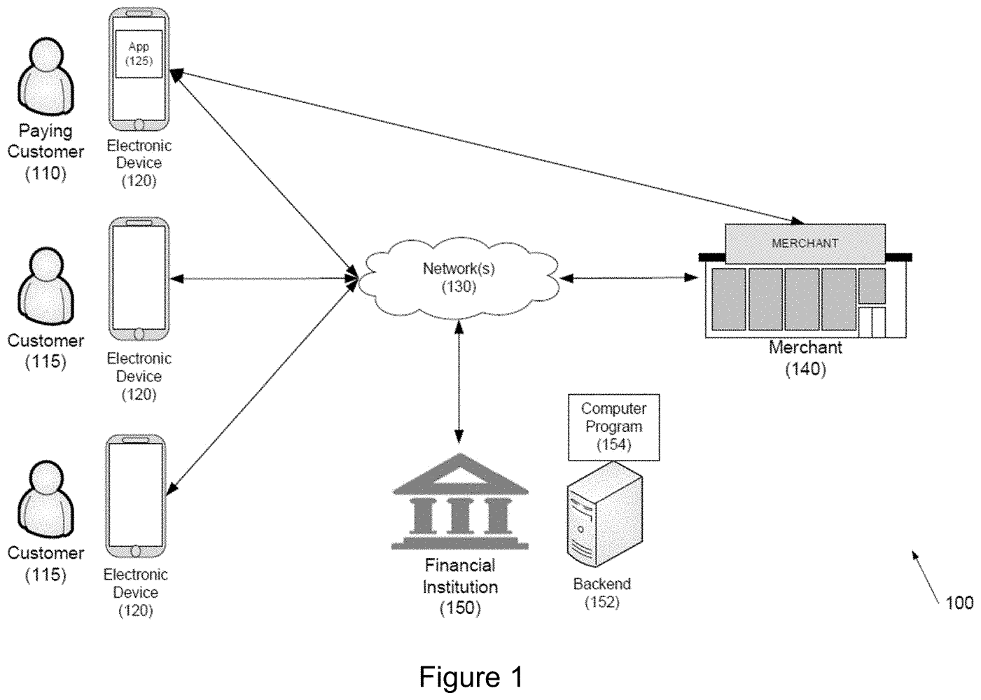

FIG. 1 depicts a system for splitting bills according to an exemplary embodiment. According to one embodiment, system 100 may include a plurality of electronic devices 120, each electronic device associated with a customer 110, 115. According to one embodiment, electronic devices 120 may communicate with financial institution 150, which may host or be associated with backend 152 that may execute computer program or application 154 that may manage transaction splitting.

Electronic device 120 may be any suitable electronic device, including, for example, smartphones, smart watches, laptop computers, notebook computers, desktop computers, tablet computers, workstations, Internet of Things (IoT) appliances, etc.

Merchant 140 may further communicate with one or more of electronic devices 120 and financial institution 150 over one or more network 130. Network 130 may be any suitable network or combination of networks, such as communications networks, payment networks, etc.

According to one embodiment, one or more of electronic devices 120 may execute computer program or application 125 for managing transaction splitting. According to one embodiment, computer program or application 125 may be a computer program or application provided by financial institution 150, a website for financial institution 150, a payment application provided by a third party, etc.

According to one embodiment, paying customer 110 may present a financial instrument to merchant 140 for payment for a transaction or transactions, and paying customer 110 may desire to allocate a portion of the transaction or transactions to customers 115 for reimbursement. For example, customers 110 and 115 may attend an event together (for example go to a restaurant, sporting event, movie, etc.), may share services (for example utilities, rent, etc.), or may be involved in any transaction or transactions suitable for splitting among customers 110 and 115. According to one embodiment, customer 110 may use computer program 125 executed on his or her electronic device 120 and/or computer program or application 154 executed by backend 152 to facilitate the splitting and reimbursement.

Although only three customers 110 and 115 are depicted in FIG. 1, it should be recognized that a greater or fewer number of customers 115 may be involved in the transaction.

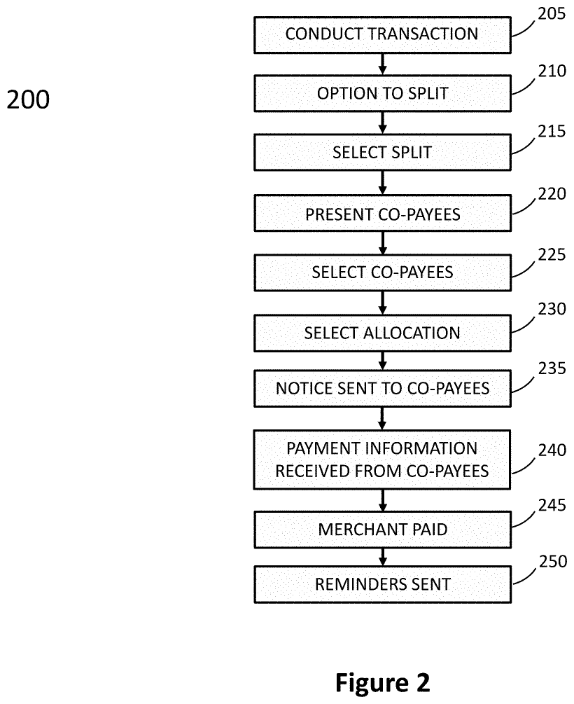

Referring to FIG. 2, a method for splitting bills is depicted according to one embodiment.

In step 205, on behalf of a group of customers, a paying customer may present a financial instrument to a merchant for a transaction. According to one embodiment, the transaction may be related to goods or services that are received or shared by the group of customers, such as a restaurant outing, sporting event or concert tickets, movie tickets, utility payments, rent, etc.

According to one embodiment, the paying customer pay present a physical financial instrument (for example a credit or debit card), an electronic payment (for example ACH, wire), a mobile-device based payment (for example ApplePay), a check, etc.

According to one embodiment, there may be a group of transactions at the merchant.

In step 210, at the time of the transaction, or after the transaction has posted, the paying customer may be presented with transaction details for the transaction in, for example, a payment application, a website, etc. that may be provided by a financial institution, a payment aggregator, a financial technology services provider, etc.

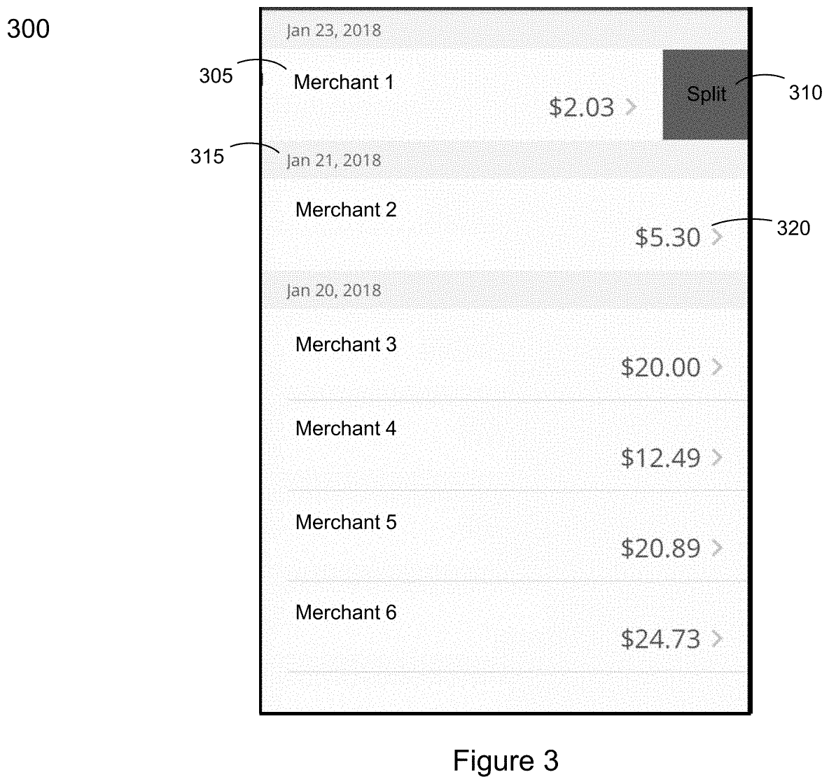

According to one embodiment, the transaction details may be provided by the payment application on an interface, for example as illustrated in FIG. 3.

According to one embodiment, the customer may be presented with transaction details for a single transaction or a group of transactions. The prompt may occur after a single transaction or a group of transactions.

Referring to FIG. 3, interface 300 may be provided on a display on an electronic device, for example a mobile device. According to one embodiment, interface 300 may be provided by a computer program or application provided by an issuer of a credit or debit account. Interface 300 may include a list of transactions and associated metadata, for example dates 315, merchant names or other identifiers 305, transaction amounts 320, etc.

According to one embodiment, interface 300 may allow a paying customer to initiate a split payment request by selecting a particular transaction. According to one embodiment, interface 300 may be provided on a touch screen, and a paying customer may initiate a split payment request by swiping to the left or to the right on a particular transaction, bringing up a “Split” option 310.

According to one embodiment, multiple transactions may be selected simultaneously for a split payment request.

According to one embodiment, the system for splitting bills and payment requests directly from an account activity view in a debit or credit account may apply machine learning to suggest or recommend transactions that may be candidates for payment splitting. The payment application may, for example, suggest transactions based on the dollar amount of the transaction (for example identifying high dollar amount transactions as associated with split payment requests), the type of merchant (for example a restaurant, sporting event, a movie, etc.), the time of day (for example weekends may be more likely to involve split payment requests), experience with similar transactions, experience with similar customers, etc.

Referring again to FIG. 2, in step 215, the payment application, website, etc. may present the paying customer with an option to split the cost for the transaction or transactions among one or more of the customers in the group of customers. According to one embodiment, the payment application may apply machine learning to the paying customer's transaction history and/or the paying customer's past split payment request history in order to suggest or recommend a split payment request for a transaction. The payment application may, for example, suggest transactions based on the dollar amount of the transaction (for example identifying high dollar amount transactions as associated with split payment requests), the type of merchant (for example a restaurant, sporting event, etc.), the time of day (for example weekends may be more likely to involve split payment requests), experience with similar transactions, experience with other customers, etc.

In step 215, the paying customer may select a split payment option using the payment application. According to one embodiment, the paying customer may identify a single transaction; in another embodiment, the paying customer may select multiple transactions.

According to one embodiment, the payment application may present the split payment option on a graphical interface. An exemplary interface is illustrated in FIG. 3.

In step 220, the payment application may present the paying customer with a list of potential other customers with whom the paying customer may generate a split payment request or a reimbursement request. According to one embodiment, the list of potential other customers may include contacts from one or more of: contacts on the paying customer's electronic device, contacts from one or more social networking sites, people who were at the same location at the same time based on one or more social networking sites or based on electronic location identification (e.g., GPS, beacons, etc.) of associated electronic devices, the paying customer's known family members, or any other source of contacts as desired.

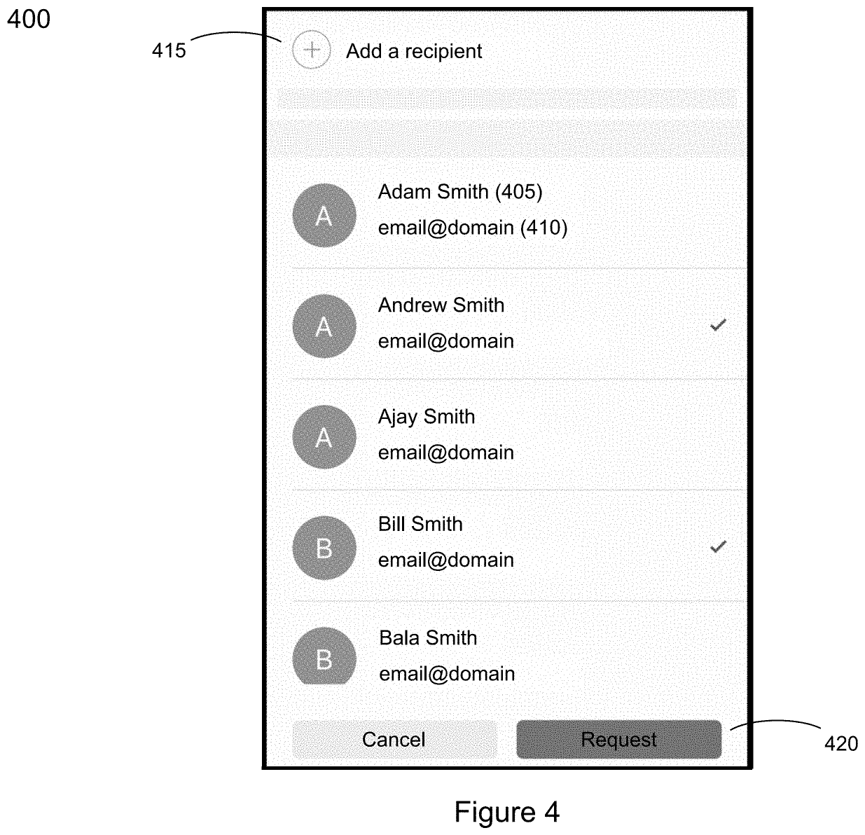

According to one embodiment, the payment application may present the list of potential other customers on a graphical user interface that includes name, telephone, email information, or any other information about each other customer as desired, for each potential other customer. An exemplary interface is illustrated in FIG. 4.

Referring to FIG. 4, interface 400 may be provided on a display on an electronic device, for example a mobile device. According to one embodiment, interface 400 may be provided by a computer program or application provided by an issuer of a credit or debit account.

Interface 400 may include a list of potential other customers for a split payment request, for example, names 405, emails 410, etc. Interface 400 may also include option 415 to add an other customer manually.

According to one embodiment, the list of potential other customers may include contacts from one or more of: contacts on the paying customer's electronic device, contacts from one or more social networking sites, people who were at the same location at the same time based on one or more social networking sites, the paying customer's known family members, or any other source of contacts as desired.

According to one embodiment, the system for splitting bills and payment requests directly from an account activity view in a debit or credit account may apply machine learning to suggest or recommend which other customers to add to the split payment request. The system may, for example, suggest contacts based on the dollar amount of the transaction, the type of merchant (for example a restaurant, sporting event, etc.), the location, the time of day, experience with similar transactions, experience with similar customers, etc.

Referring again to FIG. 2, in one embodiment, the payment application may apply machine learning to the paying customer's transaction history and/or the paying customer's past split payment request history in order to suggest or recommend potential other customers. For example, if the paying customer has gone to a certain restaurant with another customer before, that other customer may be recommended for the payment split request.

In one embodiment, the suggested other customer(s) may be presented at the top of the list of potential other customers.

In step 225, the paying customer may select one or more other customers from the list of potential other customers.

In step 230, the payment application may present the paying customer with options as to how to allocate the costs of the transaction or transactions among the other customers. According to one embodiment, the payment application may include options for one or more of: splitting the cost evenly, splitting the cost by percentages of the total, splitting the cost by set amounts of dollars or other currency, splitting the cost for amount less than the total cost of the transaction, and using a saved allocation, or any other means to allocate cost as desired.

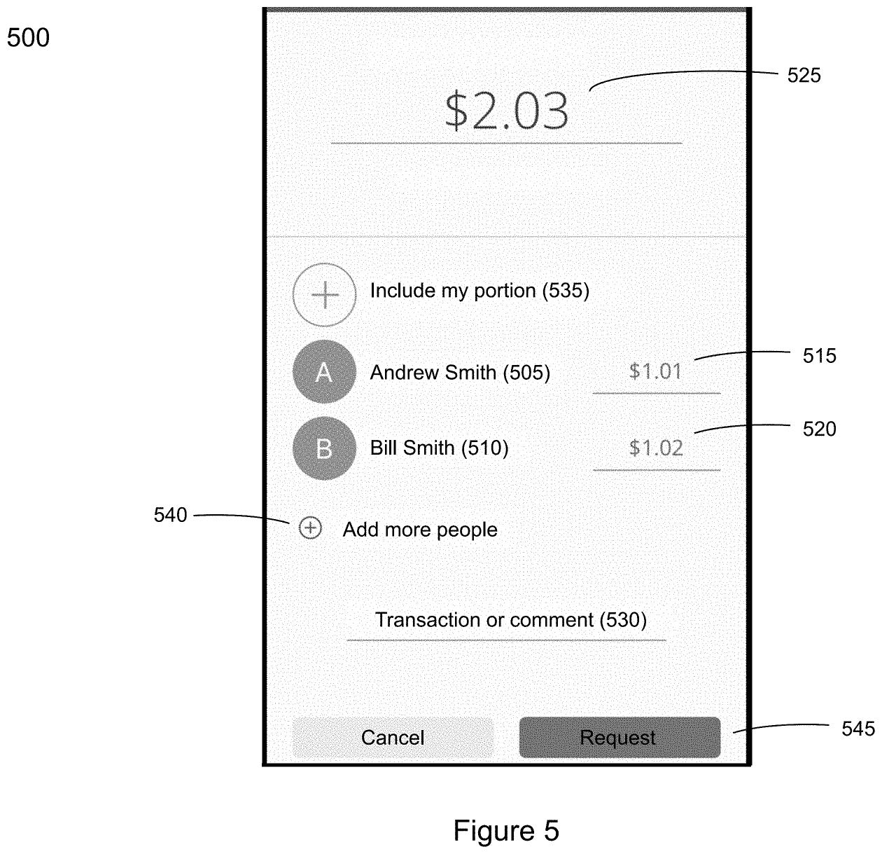

According to one embodiment, the payment application may present the allocation options on a graphical interface. An exemplary interface is illustrated in FIG. 5.

Referring to FIG. 5 interface 500 may be provided on a display on an electronic device, for example a mobile device. According to one embodiment, interface 500 may be provided by a computer program or application provided by an issuer of a credit or debit account.

Interface 500 may include such information as a list of selected other customers for a split payment request (for example 505 and 510), the amount to request from each selected other customer (for example 515 and 520), the total amount to split (for example 525), and a transaction name/ID or comment about the transaction or transactions (for example 540). Interface 500 may also include an option to add additional other customers (for example 540) or to include the paying customer in the list of payment request other customers (for example 535).

According to one embodiment, adding the paying customer to the list of other customers (such as through illustrated button 535) does not prepare a request for payment to the paying customer but merely adds the paying customer's share to the payment request amount calculation.

According to one embodiment, the interface may include options for one or more of: splitting the cost evenly, splitting the cost by percentages of the total, splitting the cost by set amounts of dollars or other currency, splitting the cost for amount less than the total cost of the transaction, and using a saved allocation, or any other means to allocate cost as desired.

Once the other customers are finalized and the amount distributed as desired, a paying customer may send the split payment request by, for example, selecting option 545. Option 545 may be provided as a virtual button, virtual key, or any suitable interface.

Referring again to FIG. 2, in step 235, the payment application may communicate a payment request, or a reimbursement request, to the selected other customers according to the selected allocation. According to one embodiment, this may be sent by email, SMS, push notification, in-app notification, etc.

According to one embodiment, the payment request may include an in-messaging payment option, a link to provide payment information, a person-to-person payment option, etc.

According to one embodiment, the payment application may communicate the payment request to a backend to be forwarded along to the selected other customers. According to one embodiment, the backend may be a remote server.

According to one embodiment, the backend may send a confirmation message to the payment application that it has sent the payment request to the selected other customers.

In step 240, the payment application or backend may receive payment information from one or more of the selected other customers for the payment allocation.

In step 245, the payment application or backend may send payment to one or more merchants associated with the one or more selected transactions.

In another embodiment, the payment application or backend may conduct a transaction to reimburse the paying customer for the payment amount. According to one embodiment, this may involve charging the other customer's credit card, conducting an ACH transaction, netting an amount that the paying customer may owe the other customer, etc.

According to one embodiment, the backend may send a confirmation message to the payment application that it has sent payment to the one or more merchants.

At step 250, periodically, if payment information for the payment allocation has not been received, the payment application or backend may communicate a reminder to the other customer.

According to one embodiment, the remote server may send confirmation messages to the app after sending the split payment requests and after sending payment.

According to one embodiment, the split payment request may be generated at the time of a transaction or before a transaction is complete. According to one embodiment, the split payment request may be generated after a transaction has posted.

According to one embodiment, the payment request may go through the user's financial system. According to another embodiment, the payment request may go through a third party person-to-person payment platform.

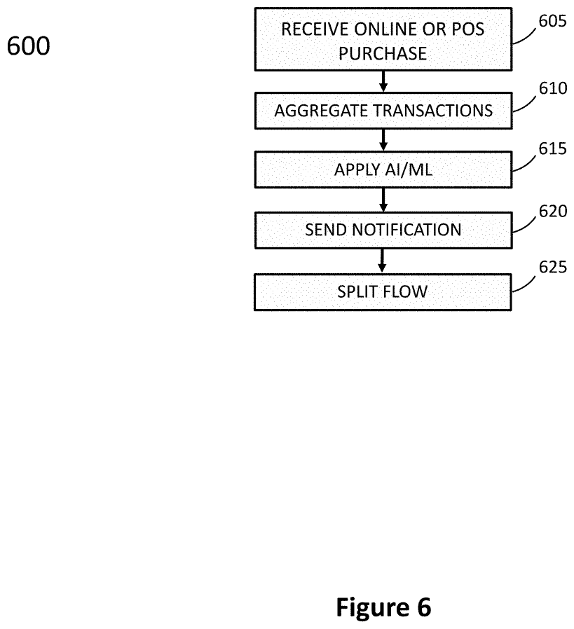

FIG. 6 depicts a flowchart of a method for splitting bills according to an exemplary embodiment.

In step 605, a customer may conduct a transaction online or at a point-of-sale (POS) terminal, for example, using a physical card or a wallet. This transaction may be through a checking account, a savings account, a credit card, or any other kind of financial account as desired. A payment authorization may be posted on the customer's account, and the associated financial system may debit and hold funds until the merchant makes a claim for them.

In step 610, transactions posted on the customer's accounts may be pushed to a transaction aggregator.

In step 615, artificial intelligence/machine learning (AI/ML) algorithms and models may be run on the aggregated data to search for a specific pattern with a particular transaction. For example, if a customer usually spends $15 in Chipotle, and the average spend in Chipotle across many customers is $20, but a $60 transaction is posted, a machine learning model may detect that exceptional event/trigger and push the transaction to a personalization engine.

In one embodiment, the AI/ML algorithms and models may look only at one customer's transaction data. In another embodiment, the AI/ML algorithms may look at the transaction data of multiple customers.

In one embodiment, the AI/ML algorithms and models may look at groups of transactions at once instead of selecting individual transactions. Split payment requests may then be done in groups. For example, if a customer goes on a trip to Los Angeles with friends, the ML models may identify a set of transactions done in LA with the group of friends. The set of transactions done in LA can be recommended as a set for a split payment request, rather than a series of individual recommendations and requests.

In step 620, the personalization engine may prompt the customer to split the transaction by sending a notification. The prompt may be by any suitable communication method, including push notification, email, a text message, a notification on next login to a mobile app or website, etc. AI/ML algorithms and models may advantageously allow the personalization engine to push an alert where a split payment request is desired or needed, as opposed to pushing out an alert for every transaction.

In one embodiment, a group of transactions for splitting may be recommended via notification to the customer. A customer may see a group of transactions and either remove or add transactions, and may then choose to initiate a split payment request.

In step 625, the split flow may be initiated, for example as illustrated in FIG. 2.

Hereinafter, general aspects of implementation of the systems and methods of the embodiments will be described.

The system of the embodiments or portions of the system of the embodiments may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

According to one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the embodiments may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the embodiments.

The processing machine used to implement the embodiments may utilize a suitable operating system. Thus, embodiments may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the methods as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment, be performed by a single component. Further, the processing performed by one distinct component as described above may be performed by two distinct components. In a similar manner, the memory storage performed by two distinct memory portions as described above may, in accordance with a further embodiment, be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the embodiments. Rather, any number of different programming languages may be utilized as is necessary and/or desirable.

Also, the instructions and/or data used in the practice of the embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the embodiments may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the embodiments.

Further, the memory or memories used in the processing machine that implements the embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the embodiments, a variety of “user interfaces” may be utilized to allow a user to interface with the processing machine or machines that are used to implement the embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method of the embodiments may interact partially with another processing machine or processing machines, while also interacting partially with a human user.

It will be readily understood by those persons skilled in the art that the present embodiments are susceptible to broad utility and application. Many embodiments and adaptations other than those herein described, as well as many variations, modifications and equivalent arrangements, will be apparent from or reasonably suggested by the present embodiments and foregoing description thereof, without departing from the substance or scope of the invention.

Accordingly, while the present exemplary embodiments have been described here in detail, it is to be understood that this disclosure is only illustrative and exemplary and is made to provide an enabling disclosure of the invention. Accordingly, the foregoing disclosure is not intended to be construed or to limit the present embodiments or otherwise to exclude any other such embodiments, adaptations, variations, modifications or equivalent arrangements.

1. A computer-implemented method for sending a split payment request comprising the steps of:
in a mobile payment computer application executed by an information processing apparatus comprising at least one computer processor and associated with a customer:
receiving a split payment request for a transaction with a merchant comprising a transaction amount;
automatically identifying a plurality of other potential customers to split the transaction amount with based on at least one prior transaction with the merchant, the customer and the plurality of other potential customers;
displaying a list comprising the customer and the plurality of other potential customers for the split payment request;
receiving a selection of one of the plurality of other potential customers for the split payment request;
receiving a selection of a payment allocation of the transaction amount for the selected other potential customer; and
communicating the split payment request, the selected other potential customer, and the payment allocation to a remote server.

2. The method of claim 1, wherein the mobile payment computer application enables a paying customer to select a transaction for the split payment request on a touch screen interface by swiping to the left or right on the transaction.

3. The method of claim 1, wherein the step of receiving a split payment request is for two or more transactions.

4-5. (canceled)

6. The method of claim 1, comprising the additional step of sending a reminder to the selected other potential customer after the split payment request has been sent.

7-11. (canceled)

12. A computer-implemented system for sending a split payment request comprising:
a communications network;
an electronic device associated with a customer comprising at least one processor, coupled to the communications network; and
a server comprising at least one processor, coupled to the communications network;
wherein:
the electronic device receives an identification of a transaction with a merchant comprising a transaction amount for a split payment request;
the electronic device automatically identifies a plurality of other potential customers to split the transaction amount with based on at least one prior transaction with the merchant, the customer and the plurality of other potential customers;
the electronic device displays a list comprising the customer and the plurality of other potential customers for the split payment request;
the electronic device receives a selection of one of the plurality of other potential customers for the split payment request;
the electronic device receives a payment allocation for the selected other potential customer;
the electronic device sends the split payment request, via the communications network, to the server;
the server sends the split payment request to the selected other potential customer; and
the server receives payment information from selected other potential customer.

13. The system of claim 12, wherein the server pays one or more merchants associated with the transaction using the received payment information.

14. The system of claim 12, wherein the server conducts a transaction for the payment amount and credits it to an account associated with the customer.

15. The system of claim 12, wherein the electronic device includes a touch screen interface; and
wherein the electronic device receives an identification of a transaction for a split payment request in the form of a swipe left or swipe right on a transaction using the touch screen interface.

16. The system of claim 12, wherein the electronic device receives an identification of two transactions for a split payment request.

17. The system of claim 12, wherein:
the electronic device applies machine learning to the customer's transaction history and past split payment requests; and
the electronic device recommends a transaction for a split payment request based on the customer's transaction history and past split payment requests.

18. The system of claim 12, wherein:
the electronic device applies machine learning to the customer's transaction history and past split payment requests; and
the electronic device recommends one or more other potential customers for a split payment request based on the customer's transaction history and past split payment requests.

19. The system of claim 12, wherein the electronic device sends a reminder to the other customer after the split payment request has been sent.

20. The system of claim 12, wherein the server sends a reminder to the other potential customer after the split payment request has been sent.

21. A computer-implemented method for sending a split payment request comprising the steps of:
in a mobile payment computer application executed by an information processing apparatus comprising at least one computer processor and associated with a customer:
receiving a split payment request for a transaction with a merchant comprising a transaction amount;
automatically identifying a plurality of other potential customers to split the transaction amount with based on electronic location information for electronic devices associated with each of the plurality of other potential customers at a time of the transaction;
displaying a list comprising the customer and the plurality of other potential customers for the split payment request;
receiving a selection of one of the plurality of other potential customers for the split payment request;
receiving a selection of a payment allocation of the transaction amount for the selected other potential customer; and
communicating the split payment request, the selected other potential customer, and the payment allocation to a remote server.

22. The method of claim 21, wherein the mobile payment computer application enables a customer to select a transaction for the split payment request on a touch screen interface by swiping to the left or right on the transaction.

23. The method of claim 21, wherein the step of receiving a split payment request is for two or more transactions.

24. The method of claim 21, comprising the additional step of sending a reminder to the selected other potential customer after the split payment request has been sent.
